(19) United States
(12) Patent Application Publication
(10) Pub. No.: US 2024/0340225 A1
(43) Pub. Date: Oct. 10, 2024

(54) MACHINE LEARNING-BASED ANALYSIS OF NETWORK DEVICES UTILIZATION AND FORECASTING

(71) Applicant: Cisco Technology, Inc., San Jose, CA (US)

(72) Inventors: Evan K Pease, Walnut Creek, CA (US); Mohammad Shami, Foster City, CA (US); Yao Zhao, San Bruno, CA (US); Younghwan Go, San Francisco, CA (US)

(21) Appl. No.: 18/296,058

(22) Filed: Apr. 5, 2023

(51) Int. Cl. H04L 41/16; G06N 20/00

(52) U.S. Cl. CPC H04L 41/16; G06N 20/00

(57) ABSTRACT

In one aspect, a method of utilization analysis of network devices include receiving a set of information associated with performance of the network devices operating in a network, processing using a trained machine learning model the set of information to identify one or more variables indicative of performance of the network devices, the machine learning model being trained to receive as input the set of device utilization information, identify the one or more variables, and provide as output an analysis of the performance of one or more of the network devices, and generating a user interface to display on a user device a visual representation of the output of the trained machine learning model.

### FIELD OF THE TECHNOLOGY

The subject matter of this disclosure generally relates to the field of computer networks, and more particularly to methods of pre-change utilization analysis of network devices.

### BACKGROUND

The monitoring of network devices provides the ability to monitor the overall health and connectivity of devices in a network system. Performing the analysis of these network devices provides the ability to detect device or connection failures or issues such as traffic bottlenecks that limit data flow. An example of tracking and monitoring in an enterprise network would be a network monitoring system that provide reports on how network components are performing over a defined period, and under certain conditions. By analyzing these reports, network administrators can anticipate when the organization can need to consider changing the network parameters of the network devices in order to ensure limited downtime, and maximum efficiency.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A illustrates an example cloud computing architecture according to some aspects of the present disclosure;

FIG. 1B illustrates an example fog computing architecture according to some aspects of the present disclosure.

FIG. 2 illustrates an example process of performing utilization analysis of network devices according to some aspects of the present disclosure.

FIG. 3 illustrates an example process of performing root-cause analysis and variable identification of network devices according to some aspects of the present disclosure.

FIG. 4 illustrates an example architecture for performing root-cause analysis and variable identification of network devices according to some aspects of the present disclosure.

FIG. 5 illustrates an example architecture for performing impact prediction on future network device and network performance according to some aspects of the present disclosure.

FIG. 6 illustrates an example output displaying impact of feature values on a network according to some aspects of the present disclosure.

FIG. 7 illustrates an example output displaying impact of feature values on a network in accordance with a ranking according to some aspects of the present disclosure.

FIG. 8 illustrates an example process of performing pre-change analysis of network devices according to some aspects of the present disclosure.

FIG. 9 illustrates an example of a computing system according to some aspects of the present disclosure; and

FIG. 10 illustrates an example network device according to some aspects of the present disclosure.

### DETAILED DESCRIPTION

Various examples of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an example in the present disclosure can be references to the same example or any example; and, such references mean at least one of the examples.

Reference to “one example” or “an example” means that a particular feature, structure, or characteristic described in connection with the example is included in at least one example of the disclosure. The appearances of the phrase “in one example” in various places in the specification are not necessarily all referring to the same example, nor are separate or alternative examples mutually exclusive of other examples. Moreover, various features are described which can be exhibited by some examples and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various examples given in this specification.

Without intent to limit the scope of the disclosure, examples of instruments, apparatus, methods and their related results according to the examples of the present disclosure are given below. Note that titles or subtitles can be used in the examples for convenience of a reader, which in no way should limit the scope of the disclosure. Unless otherwise defined, technical and scientific terms herein have the meaning commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

### Overview

Support and engineering organizations need to understand the confluence of configuration and load conditions under which devices underperform despite being configured and loaded in the specifications. Upon experiencing a network issue resulting in high packet loss, latency and poor user experience, clarity often is sought as to the cause of the issue. Thus, network device utilization can be monitored in order to determine the cause of various conditions, to decipher remedies to the root cause of the underperformance.

The present disclosure is directed toward methods of utilization analysis of network devices.

In one aspect, a method of utilization analysis of network devices include receiving a set of information associated with performance of the network devices operating in a network, processing using a trained machine learning model the set of information to identify one or more variables indicative of performance of the network devices, the machine learning model being trained to receive as input the set of device utilization information, identify the one or more variables, and provide as output an analysis of the performance of one or more of the network devices, and generating a user interface to display on a user device a visual representation of the output of the trained machine learning model.

In another aspect, the set of information include CPU load features, packet loss features, traffic volume features, configuration features of the network devices, one or more of current device utilization, traffic levels, and feature usage of the network devices.

In another aspect, the analysis is a root cause analysis of how the one or more variables are affecting the performance of the one or more of the network devices.

In another aspect, the method further comprises identifying the one or more variables affecting the performance of the network devices.

In another aspect, the analysis includes at least one corrective action to be taken to address the performance of the one or more of the network devices.

In another aspect, the analysis is a pre-change analysis of how a change in at least one of the one or more variables affects a future performance of the one or more of the network devices.

In another aspect, the one or more variables include one or more device configurations and modifications in a number of the network devices operating in the network.

In one aspect, a network device includes one or more memories having computer-readable instructions stored therein, and one or more processors. The one or more processors are configured to execute the computer-readable instructions to receive a set of information associated with performance of the network devices operating in a network, process using a trained machine learning model the set of information to identify one or more variables indicative of performance of the network devices, the machine learning model being trained to receive as input a set of device utilization information, identify the one or more variables, and provide as output an analysis of the performance of one or more of the network devices, and generate a user interface to display on a user device a visual representation of the output of the trained machine learning model.

In one aspect, one or more non-transitory computer readable media include computer-readable instructions, which when executed by one or more processors of a network appliance, cause the network appliance to receive a set of information associated with performance of network devices operating in a network, process using a trained machine learning model the set of information to identify one or more variables indicative of performance of the network devices, the machine learning model being trained to receive as input a set of device utilization information, identify the one or more variables, and provide as output an analysis of the performance of one or more of the network devices, and generate a user interface to display on a user device a visual representation of the output of the trained machine learning model.

### Example Embodiments

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

Support and engineering organizations currently lack the ability to monitor network conditions in enterprise network to understand the confluence of configuration and load conditions under which devices (e.g., routers, network appliances, network devices radio nodes, etc.) perform. Based on the performance of the devices, network conditions are often affected without any means of understanding the impact of possible changes to device configurations and/or understanding the impact of addition and removal of network devices, on network performance. Furthermore, updated specifications are loaded and deployed, as network configurations, in order to address various network conditions that can affected the performance of each of the devices.

In an example, a user can experience poor network conditions effecting the performance of a network device. The poor network conditions can include high packet loss, and latency in a wide area network link, and poor user experience while navigating the Internet. Upon determining that the network device is overloaded, clarity is needed as to what has caused the poor performance, in addition to a recommendation of improving the performance. Oftentimes, multiple iterations of analysis, and troubleshooting become the norm, which could increase the amount of downtime or poor performance additional network devices in the networks could experience.

The disclosed technology addresses the need in the art for identifying the root cause of changes in network performance, and variables or parameters that can be affecting the performance at a network device. As will be described below, a model can be generated that automates estimation of impact of possible changes, such as device configurations on network devices, the addition or removal of devices to the network, and network performance. The network performance of the network and the network device can be enhanced based on the model recommendation.

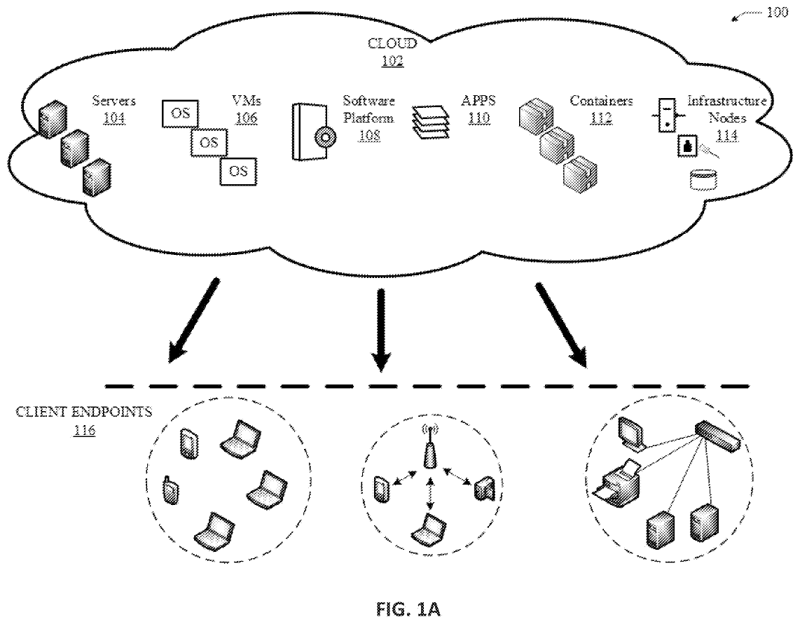

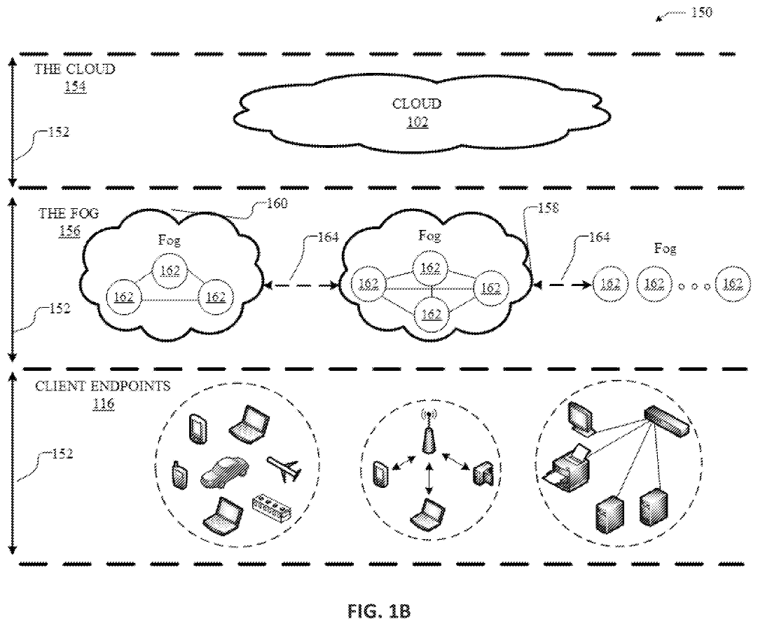

Prior to describing the proposed techniques and methods, example network environments and architectures for network data access and services, as illustrated in FIG. 1A, and FIG. 1B, are described first.

FIG. 1A illustrates a diagram of an example cloud computing architecture according to some aspects of the present disclosure. The architecture 100 can include a cloud 102. The cloud 102 can be used to form part of a TCP connection or otherwise be accessed through the TCP connection. Specifically, the cloud 102 can include an initiator or a receiver of a TCP connection and be utilized by the initiator or the receiver to transmit and/or receive data through the TCP connection. The cloud 102 can include one or more private clouds, public clouds, and/or hybrid clouds. Moreover, the cloud 102 can include cloud elements 104-114. The cloud elements 104-114 can include, for example, servers 104, virtual machines (VMs) 106, one or more software platforms 108, applications or services 110, software containers 112, and infrastructure nodes 114. The infrastructure nodes 114 can include various types of nodes, such as compute nodes, storage nodes, network nodes, management systems, etc.

The cloud 102 can be used to provide various cloud computing services via the cloud elements 104-114, such as SaaSs (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), and other types of services such as desktop as a service (DaaS), information technology management as a service (ITaaS), managed software as a service (MSaaS), mobile backend as a service (MBaaS), etc.

The client endpoints 116 can connect with the cloud 102 to obtain one or more specific services from the cloud 102. The client endpoints 116 can communicate with elements 104-114 via one or more public networks (e.g., Internet), private networks, and/or hybrid networks (e.g., virtual private network). The client endpoints 116 can include any device with networking capabilities, such as a laptop computer, a tablet computer, a server, a desktop computer, a smartphone, a network device (e.g., an access point, a router, a switch, etc.), a smart television, a smart car, a sensor, a GPS device, a game system, a smart wearable object (e.g., smartwatch, etc.), a consumer object (e.g., Internet refrigerator, smart lighting system, etc.), a city or transportation system (e.g., traffic control, toll collection system, etc.), an internet of things (IoT) device, a camera, a network printer, a transportation system (e.g., airplane, train, motorcycle, boat, etc.), or any smart or connected object (e.g., smart home, smart building, smart retail, smart glasses, etc.), and so forth.

FIG. 1B illustrates a diagram of an example fog computing architecture according to some aspects of the present disclosure. The fog computing architecture 150 can be used to form part of a TCP connection or otherwise be accessed through the TCP connection. Specifically, the fog computing architecture can include an initiator or a receiver of a TCP connection and be utilized by the initiator or the receiver to transmit and/or receive data through the TCP connection. The fog computing architecture 150 can include the cloud layer 154, which includes the cloud 102 and any other cloud system or environment, and the fog layer 156, which includes fog nodes 162. The client endpoints 116 can communicate with the cloud layer 154 and/or the fog layer 156. The fog computing architecture 150 can include one or more communication links 152 between the cloud layer 154, the fog layer 156, and the client endpoints 116. Communications can flow up to the cloud layer 154 and/or down to the client endpoints 116.

The fog layer 156 or “the fog” provides the computation, storage and networking capabilities of traditional cloud networks, but closer to the endpoints. The fog can thus extend the cloud 102 to be closer to the client endpoints 116. The fog nodes 162 can be the physical implementation of fog networks. Moreover, the fog nodes 162 can provide local or regional services and/or connectivity to the client endpoints 116. As a result, traffic and/or data can be offloaded from the cloud 102 to the fog layer 156 (e.g., via fog nodes 162). The fog layer 156 can thus provide faster services and/or connectivity to the client endpoints 116, with lower latency, as well as other advantages such as security benefits from keeping the data inside the local or regional network(s).

The fog nodes 162 can include any networked computing devices, such as servers, switches, routers, controllers, cameras, access points, gateways, etc. Moreover, the fog nodes 162 can be deployed anywhere with a network connection, such as a factory floor, a power pole, alongside a railway track, in a vehicle, on an oil rig, in an airport, on an aircraft, in a shopping center, in a hospital, in a park, in a parking garage, in a library, etc.

In some configurations, one or more fog nodes 162 can be deployed within fog instances 158, 160. The fog instances 158, 160 can be local or regional clouds or networks. For example, the fog instances 158, 160 can be a regional cloud or data center, a local area network, a network of fog nodes 162, etc. In some configurations, one or more fog nodes 162 can be deployed within a network, or as standalone or individual nodes, for example. Moreover, one or more of the fog nodes 162 can be interconnected with each other via links 164 in various topologies, including star, ring, mesh or hierarchical arrangements, for example.

In some cases, one or more fog nodes 162 can be mobile fog nodes. The mobile fog nodes can move to different geographic locations, logical locations or networks, and/or fog instances while maintaining connectivity with the cloud layer 154 and/or the endpoints 116. For example, a particular fog node can be placed in a vehicle, such as an aircraft or train, which can travel from one geographic location and/or logical location to a different geographic location and/or logical location. In this example, the particular fog node can connect to a particular physical and/or logical connection point with the cloud layer 154 while located at the starting location and switch to a different physical and/or logical connection point with the cloud layer 154 while located at the destination location. The particular fog node can thus move within particular clouds and/or fog instances and, therefore, serve endpoints from different locations at different times.

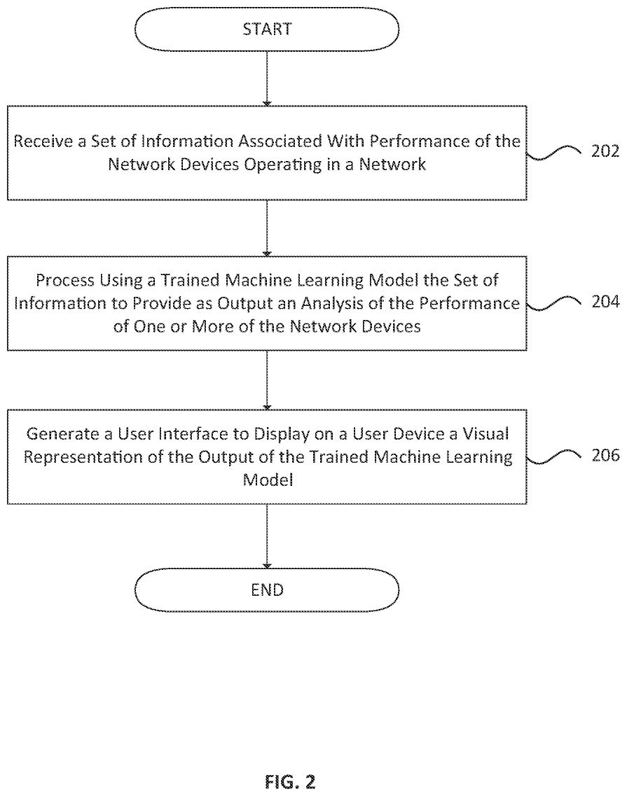

FIG. 2 illustrates an example method 200 for utilization analysis of network devices. Although the example method 200 depicts a particular sequence of operations, the sequence can be altered without departing from the scope of the present disclosure. For example, some of the operations depicted can be performed in parallel or in a different sequence that does not materially affect the function of the method 200. In other examples, different components of an example device or system that implements the method 200 can perform functions at substantially the same time or in a specific sequence.

At step 202, the method includes receiving a set of information associated with performance of the network devices operating in a network. For example, one or more of servers 104 illustrated in FIG. 1A can receive a set of information associated with performance of the network devices operating in a network. In some examples, the set of information include CPU load features, packet loss features, traffic volume features, and configuration features of the network devices. The set of information can further include one or more of current device utilization, traffic levels, and feature usage of the network devices.

At step 204, the method includes processing, using a trained machine learning model, the set of information to identify one or more variables indicative of performance of the network devices. For example, one or more of servers 104 illustrated in FIG. 1A can process using a trained machine learning model the set of information to identify one or more variables indicative of performance of the network devices.

In some examples, a root cause analysis can be performed to determine how the one or more variables are affecting the performance of the one or more network devices. The analysis can include at least one corrective action to be taken to address the performance of the one or more network devices or serve as a pre-change analysis of how a change in at least one of the one or more variables affects a future performance of the one or more of the network devices.

In some examples, the machine learning model can be trained to receive as input the set of device utilization information, identify the one or more variables, and provide as output an analysis of the performance of one or more of the network devices. The one or more variables can include one or more device configurations and modifications in a number of the network devices operating in the network.

Further, the method comprises identifying the one or more variables affecting the performance of the network devices. For example, one or more of servers 104 illustrated in FIG. 1A can identify the one or more variables affecting the performance of the network devices.

At step 206, the method includes generating a user interface to display on a user device a visual representation of the output of the trained machine learning model. For example, one or more of servers 104 illustrated in FIG. 1A can generate a user interface to display on a user device a visual representation of the output of the trained machine learning model. A user device can be one or more of client endpoints 116 or can be another terminal accessible by a network operator/manager to control operation of network 100.

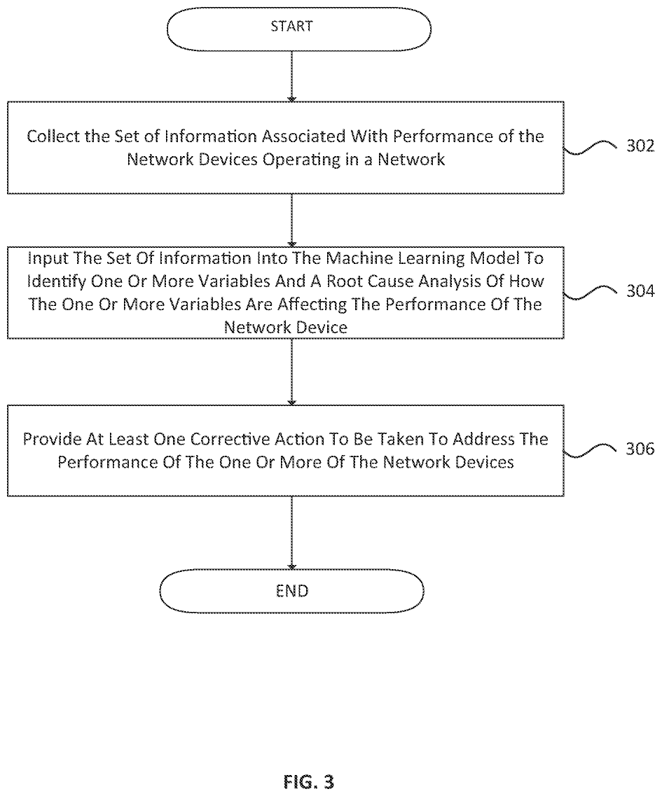

The visual representation of the output of the trained machine learning model can be an analysis of the one or more variables indicative of performance of the network devices. The process of performing the root cause analysis and variable identification, demonstrating how the one or more variables are affecting the performance of the one or more of the network devices performed, is further discussed below with reference to FIG. 3.

FIG. 3 illustrates an example process of performing root-cause analysis and variable identification of network devices according to some aspects of the present disclosure. The machine learning model according to example embodiments disclosed herein, can take a holistic approach to understanding variables that can play a role in network underperformance and identify the most impactful factors that affect network device performance. The output from the machine learning model can include the root cause analysis of what is causing the underperformance.

At step 302, the method includes collecting the set of information associated with performance of the network devices operating in a network. The set of information can be the same as described above with reference to step 202 of FIG. 2. For example, one or more of servers 104 in FIG. 1A can collect information related to the performance of infrastructure nodes 114, endpoints 116, and/or any other network element identified in example systems 100 and 150 of FIGS. 1A and 1B.

At step 304, the method includes inputting the set of information into the machine learning model to identify one or more variables and a root cause analysis of how the one or more variables affecting the performance of the network device at step 304. The machine learning model can then identify one or more variable that are the root cause of underperformance of at least one of the infrastructure nodes 114.

At step 306, the method includes providing at least one corrective action to be taken to address the performance of the one or more of the network devices at step 306. For example, corrective action can be recommended to a controller of an enterprise network, or the network device, that can resolve the affected performance. Non-limiting examples of a corrective action include, but are not limited to, adjusting IDS ruleset selection, reducing a number of flow preferences, and adjusting traffic shaping settings. The corrective action can be implemented automatically by the network device or a controller of the enterprise network through updating the network device's configurations. The automatic changes can provide a specific remedial action addressing the underperformance, or a set of recommendations of corrective actions to be taken with respect to the network devices to remedy the root cause of the underperformance.

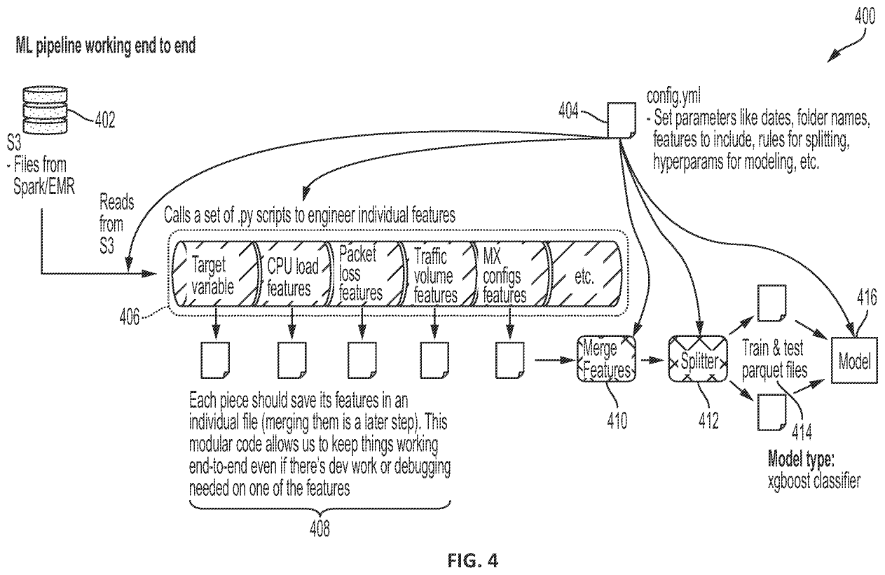

FIG. 4 illustrates an example architecture 400 for a machine learning engine 406 performing a root-cause analysis and variable identification of network devices according to some aspects of the present disclosure. The machine learning engine 406 can take four main categories of variables as input in order to identify and predict the root cause of the underperformance. These variables can include, but are not limited to, CPU load features, packet loss features, traffic volume features, and MX configuration features.

The machine learning engine 406 can receive from a storage device 402 such as a simple storage service (S3) historical data including data of features related to the performance of a network device, over a period of time. The machine learning engine 406 can further receive a configuration element 404, such as a configuration file or a set of instructions, that includes a set of parameters including dates, folder names, features to include, rules for splitting, and hyperparams for modeling. The machine learning engine 406 can identify individual features relevant to network device performance based on a set of instructions included in the configuration element 404. The individual features can be output and saved into individual feature files 408 associated with individual features 602 including but not limited to target variables, CPU load features, pack loss features, traffic volume features, and routing device (e.g., Meraki MX) configurations features (such configuration features can include data collected on device settings using one or more sensors such as settings enabled by users of such devices). The individual feature files 408 can include feature information that ensures that configurations for each of the individual features are accounted for. The individual feature files 408 can be merged via the merging element 410, based on the set of instructions received in the configuration file. The splitter 412 can then split hyperparams for modeling, resulting in a training and testing of parquet files 414. The trained and tested parquet files 414 are subsequently output to a model 416 that also include the set of instructions from the configuration element 404. The model 416 is representative of a recommendation of corrective actions to be taken with respect to the network devices to remedy the root cause of the underperformance.

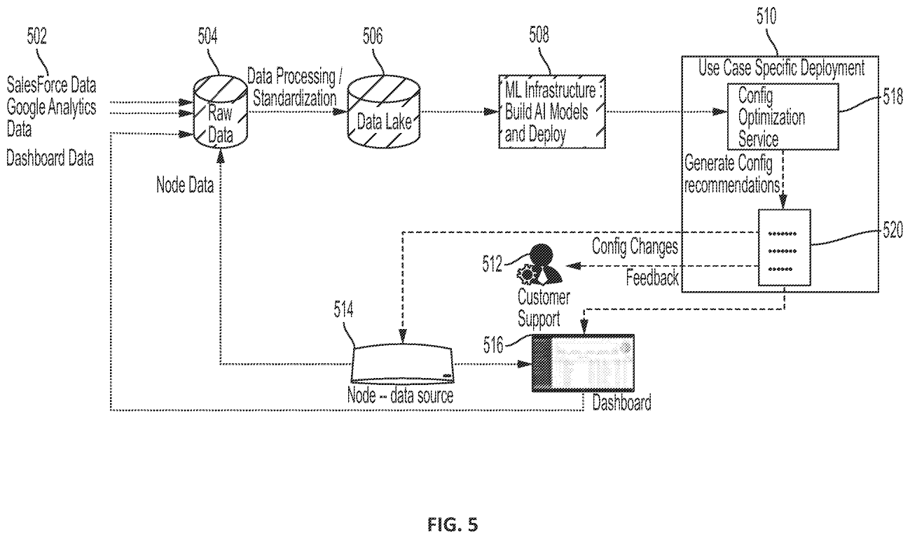

The machine learning engine can be a part of a larger system (discussed below in FIG. 5) that performs a pre change analysis of the model output from the machine learning engine 406 to be deployed for implementation of the corrective actions at the network device. The corrective actions can be representative of a prediction on the impact a future network device will have on the network performance.

FIG. 5 illustrates an example architecture for performing impact prediction on future network device and network performance according to some aspects of the present disclosure. Performing impact predictions on future network devices and network performance provides an estimate impact of possible changes on the network device, such as device configurations, addition or removal of devices to the network) and network performance.

Data analytics 502 can be received by a raw data storage 504. The data analytics 502 received by the raw data storage 504 can include fundamental information related to the enterprise entity associated with the network. The data analytics 502 stored in the raw data storage 504 can be used to identify trends related to the network devices of the network as it relates to the enterprise, performance, opportunities for enhancement of the performance and potential performance inhibitors. The raw data storage 504 is further configured to receive additional data from network devices 514 or network devices in the network, as well as dashboard 516 data comprising user inputs, and machine learning models generated by the machine learning engine 406 as provided by FIG. 4.

The raw data in the raw data storage 504 is processed or standardized and transmitted to a data lake 506. The data lake may operate as a centralized repository that stores, processes, and secures the raw data received. The data lake 506 processes the information received in the repository and transmits the processed information to a machine learning infrastructure 508 that includes a machine learning engine, as shown in FIG. 4. The machine learning infrastructure 508 processes the information received from the data lake 506, builds machine learning models, and deploys these models to be prepared for use case specific deployment 510. The models received from the machine learning infrastructure 508 are processed by a configuration optimization service 518, that generates configuration recommendations. The configuration recommendations are transmitted via the output 520 with configuration changes to the network device 514, feedback to customer support 512, and a configuration recommendation summary to the dashboard 516. The dashboard 516 is further configured to display the history of configuration recommendations provided through the user use case specific deployment 510, as well as raw data stored in the raw data storage 504, the configuration recommendations are based on.

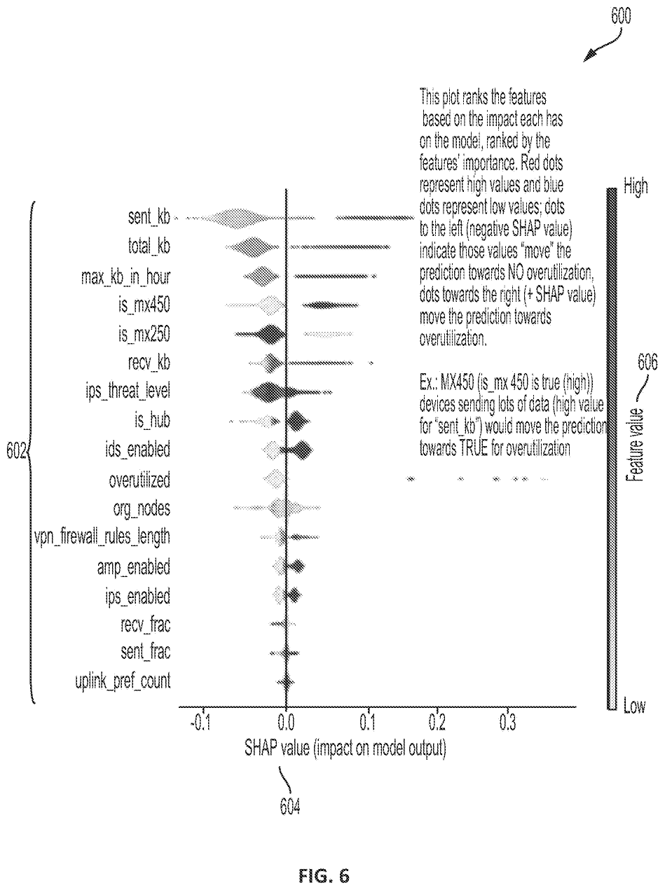

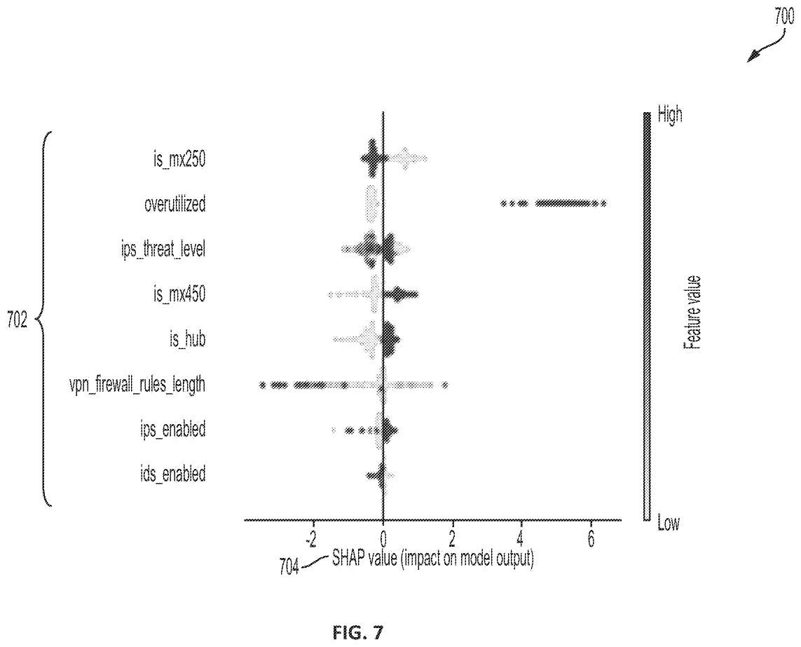

The output 520 received by the dashboard, can further include a set of Shapley (SHAP) value models, discussed below with reference to FIG. 6-7, that are displayed to represent various interpretations of the machine learning models. These interpretations can assist with identifying one or more variables and parameters that can be causing an impact on the network performance.

FIG. 6 illustrates an example output displaying impact of feature values on a network according to some aspects of the present disclosure. The SHAP model 600 include a list of variables and features 602, a SHAP value 604 indicating an impact on model output, and a feature value 606 ranked from low to high based on impact effect. The SHAP model 600 ranks each of the features 602 based on the impact each feature has on the model, ranked by the features' 602 importance. As shown in the SHAP model 600, the red dots represent a high feature value 606, and the blue dots represent low feature values. The red dots can extend horizontally, representing the SHAP value 604 indicating impact on model output. Dots to the left, representing a negative SHAP value 604, indicates that the feature 602 moves the prediction towards no overutilization of the network device. Dots to the right, representing a positive SHAP value 604, indicates that the feature 602 moves the prediction towards confirmed overutilization of the network device.

The robust overutilization learnings in FIG. 6 can further be focalized into a sampling of the features, in a separate SHAP model 700 that summarizes the ranked features 602.

FIG. 7 illustrates an example output displaying impact of feature values on a network in accordance with a ranking according to some aspects of the present disclosure. The summarized SHAP model 700 includes the features 602 of FIG. 6 summarized 702 based on a filter selected in the dashboard, or automatically based on the model generated by the machine learning infrastructure. Accordingly, the summary plot ranks the summarized features 702, and impact the summarized features 702 have on the model according to the SHAP value 704. The plotting of the summarized features 702 indicates the differences in the SHAP values 704 impacting the SHAP model 700. As shown in FIG. 7, the indicated high values of the overutilized summarized features 702, drives the model towards high SHAP values 704, which indicates a high probability of overutilization again. Conversely, the indicated low values of the overutilized summarized features 702, drive the model towards low SHAP values 704, which indicates a low probability of overutilization again.

Based on the summarized SHAP model 700, each of the summarized features 702, and features 602 of FIG. 6, can be used to determine a corrective action that can be taken to address the impact of the features causing overutilization. As such, one or more features can be recommended to be adjusted, as a corrective action, to avoid underperformance of the network device, and improve the overall operability within the enterprise network.

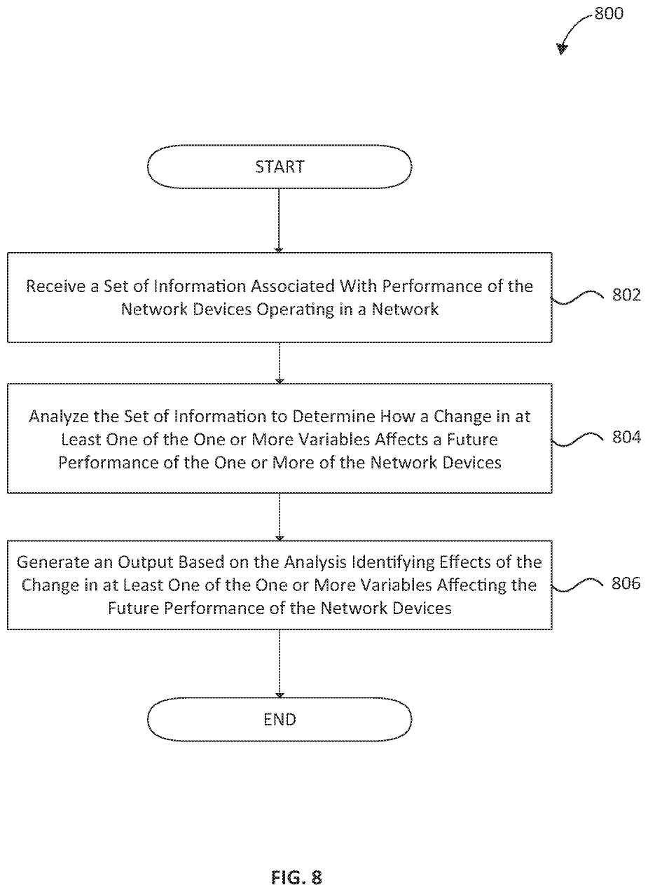

FIG. 8 illustrates an example process 800 of performing pre-change analysis of network devices according to some aspects of the present disclosure. Performing pre-change analysis of network devices in a network provides the ability to estimate impact of possible changes on a network device in the network, and the addition or removal of the network device in the network. A user can simulate based on the estimations how a proposed change, or configuration recommendation can positively and negatively affect performance of a network device, or other network devices in the network. In some examples, a simulation of an increase in traffic at the network device, or a change in a security configuration can demonstrate how the configuration recommendations impact the underperformance detected at the network device.

At step 802, the machine learning engine (e.g., engine 406 of FIG. 4) can receive a set of information associated with performance of the network devices (e.g., device 514 of FIG. 5) operating in a network. For example, the machine learning engine 406 can receive a set of variables as input in order to determine the impact of possible changes on device utilization and network performance. These variables can include CPU load features, Packet loss features, traffic volume features, and MX configuration features, among others.

At step 804, the machine learning engine (e.g., engine 406 of FIG. 4) can analyze the set of information to determine how a change in at least one of the one or more variables affects a future performance one or more of the network devices (e.g., device 514 of FIG. 5).

At step 806, the machine learning engine (e.g., engine 406 of FIG. 4) can generate an output of the analysis in step 804, identifying effects of the change in at least one of the one or more variables affecting the future performance of the network devices.

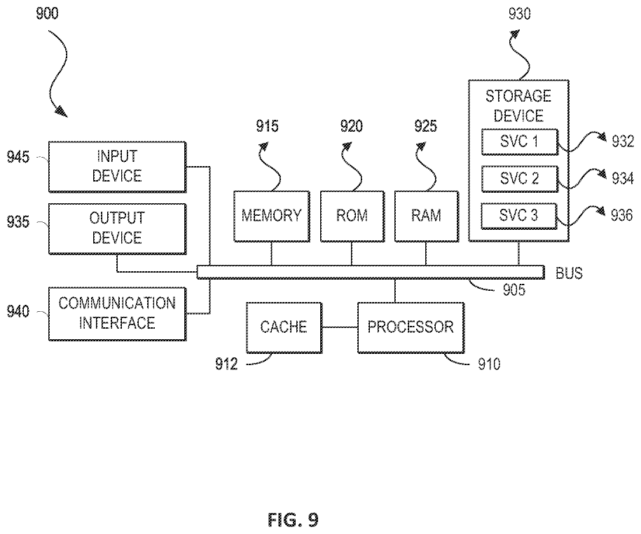

FIG. 9 shows an example of computing system 900, which can be for example any computing device making up that can perform functionalities of one or more network components described above (e.g., raw data storage 504, data lake 506, machine learning infrastructure 508, network device 514). Connection 905 can be a physical connection via a bus, or a direct connection into processor 910, such as in a chipset architecture. Connection 905 can also be a virtual connection, networked connection, or logical connection.

In some embodiments computing system 900 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 900 includes at least one processing unit (CPU or processor) 910 and connection 905 that couples various system components including system memory 915, such as read only memory (ROM) 920 and random access memory (RAM) 925 to processor 910. Computing system 900 can include a cache of high-speed memory 912 connected directly with, in close proximity to, or integrated as part of processor 910.

Processor 910 can include any general purpose processor and a hardware service or software service, such as services 932, 934, and 936 stored in storage device 930, configured to control processor 910 as well as a special-purpose processor where software instructions are incorporated into the actual processor design. Processor 910 can essentially be a completely self-contained computing system, containing multiple cores or processors, a bus, memory controller, cache, etc. A multi-core processor can be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms known to those of skill in the art. In some instances, multimodal systems can enable a user to provide multiple types of input/output to communicate with computing system 900. Computing system 900 can include communications interface 940, which can generally govern and manage the user input and system output. There is no restriction on operating on any particular hardware arrangement and therefore the basic features here can easily be substituted for improved hardware or firmware arrangements as they are developed.

Storage device 930 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 930 can include software services, servers, services, etc., that when the code that defines such software is executed by the processor 910, it causes the system to perform a function. In some embodiments, a hardware service that performs a particular function can include the software component stored in a computer-readable medium in connection with the necessary hardware components, such as processor 910, connection 905, output device 935, etc., to carry out the function.

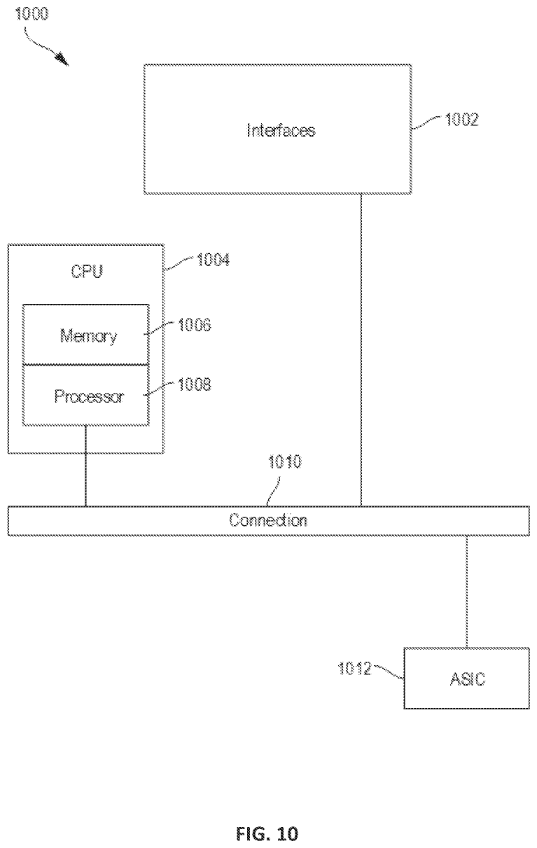

FIG. 10 illustrates an example network device 1000 suitable for performing switching, routing, load balancing, and other networking operations. The example network device 1000 can be implemented as switches, routers, nodes, metadata servers, load balancers, client devices, and so forth.

Network device 1000 includes a central processing unit (CPU) 1004, interfaces 1002, and a bus 1010 (e.g., a PCI bus). When acting under the control of appropriate software or firmware, the CPU 1004 is responsible for executing packet management, error detection, and/or routing functions. The CPU 1004 preferably accomplishes all these functions under the control of software including an operating system and any appropriate applications software. CPU 1004 can include one or more processors 1008, such as a processor from the INTEL X86 family of microprocessors. In some cases, processor 1008 can be specially designed hardware for controlling the operations of network device 1000. In some cases, a memory 1006 (e.g., non-volatile RAM, ROM, etc.) also forms part of CPU 1004. However, there are many different ways in which memory could be coupled to the system.

The interfaces 1002 are typically provided as modular interface cards (sometimes referred to as “line cards”). Generally, they control the sending and receiving of data packets over the network and sometimes support other peripherals used with the network device 1000. Among the interfaces that can be provided are Ethernet interfaces, frame relay interfaces, cable interfaces, DSL interfaces, token ring interfaces, and the like. In addition, various very high-speed interfaces can be provided such as fast token ring interfaces, wireless interfaces, Ethernet interfaces, Gigabit Ethernet interfaces, ATM interfaces, HSSI interfaces, POS interfaces, FDDI interfaces, WIFI interfaces, 3G/4G/5G cellular interfaces, CAN BUS, LoRA, and the like. Generally, these interfaces can include ports appropriate for communication with the appropriate media. In some cases, they can also include an independent processor and, in some instances, volatile RAM. The independent processors can control such communications intensive tasks as packet switching, media control, signal processing, crypto processing, and management. By providing separate processors for the communication intensive tasks, these interfaces allow the master CPU (e.g., 1004) to efficiently perform routing computations, network diagnostics, security functions, etc.

Although the system shown in FIG. 10 is one specific network device of the present disclosure, it is by no means the only network device architecture on which the present disclosure can be implemented. For example, an architecture having a single processor that handles communications as well as routing computations, etc., is often used. Further, other types of interfaces and media could also be used with the network device 1000.

Regardless of the network device's configuration, it can employ one or more memories or memory modules (including memory 1006) configured to store program instructions for the general-purpose network operations and mechanisms for roaming, route optimization and routing functions described herein. The program instructions can control the operation of an operating system and/or one or more applications, for example. The memory or memories can also be configured to store tables such as mobility binding, registration, and association tables, etc. Memory 1006 could also hold various software containers and virtualized execution environments and data.

The network device 1000 can also include an application-specific integrated circuit (ASIC), which can be configured to perform routing and/or switching operations. The ASIC can communicate with other components in the network device 1000 via the bus 1010, to exchange data and signals and coordinate various types of operations by the network device 1000, such as routing, switching, and/or data storage operations, for example.

For clarity of explanation, in some instances, the various examples can be presented as individual functional blocks comprising devices, device components, steps or routines in a method embodied in software, or combinations of hardware and software.

In some examples, the computer-readable storage devices, media, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general-purpose computer, special purpose computer, or special purpose processing device to perform a certain function or group of functions. Portions of computer resources used can be accessible over a network. The computer executable instructions can be, for example, binaries, intermediate format instructions such as assembly language, firmware, or source code. Examples of computer-readable media that can be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware, and/or software, and can take various form factors. Some examples of such form factors include general-purpose computing devices such as servers, rack mount devices, desktop computers, laptop computers, and so on, or general-purpose mobile computing devices, such as tablet computers, smartphones, personal digital assistants, wearable devices, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter can have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” refers to at least one of a set and indicates that one member of the set or multiple members of the set satisfy the claim. For example, claim language reciting “at least one of A and B” means A. B. or A and B.

What is claimed is:

1. A method of utilization analysis of network devices, the method comprising:
receiving a set of information associated with performance of the network devices operating in a network;
processing using a trained machine learning model the set of information to identify one or more variables indicative of performance of the network devices, the machine learning model being trained to receive as input the set of device utilization information, identify the one or more variables, and provide as output an analysis of the performance of one or more of the network devices; and
generating a user interface to display on a user device a visual representation of the output of the trained machine learning model.

2. The method of claim 1, wherein the set of information include CPU load features, packet loss features, traffic volume features, configuration features of the network devices, one or more of current device utilization, traffic levels, and feature usage of the network devices.

3. The method of claim 2, wherein the analysis is a root cause analysis of how the one or more variables are affecting the performance of the one or more of the network devices.

4. The method of claim 2, wherein the method further comprises:
identifying the one or more variables affecting the performance of the network devices.

5. The method of claim 1, wherein the analysis includes at least one corrective action to be taken to address the performance of the one or more of the network devices.

6. The method of claim 1, wherein the analysis is a pre-change analysis of how a change in at least one of the one or more variables affects a future performance of the one or more of the network devices.

7. The method of claim 6, wherein the one or more variables include one or more device configurations and modifications in a number of the network devices operating in the network.

8. A network device comprising:
one or more memories having computer-readable instructions stored therein; and
one or more processors configured to execute the computer-readable instructions to:
receive a set of information associated with performance of the network devices operating in a network;
process using a trained machine learning model the set of information to identify one or more variables indicative of performance of the network devices, the machine learning model being trained to receive as input a set of device utilization information, identify the one or more variables, and provide as output an analysis of the performance of one or more of the network devices; and
generate a user interface to display on a user device a visual representation of the output of the trained machine learning model.

9. The network device of claim 8, wherein the set of information include CPU load features, packet loss features, traffic volume features, configuration features of the network devices, and one or more of current device utilization, traffic levels, and feature usage of the network devices.

10. The network device of claim 9, wherein the analysis is a root cause analysis of how the one or more variables are affecting the performance of the one or more of the network devices.

11. The network device of claim 9, wherein the one or more processors are configured to execute the computer-readable instructions to identify the one or more variables affecting the performance of the network devices.

12. The network device of claim 8, wherein the analysis includes at least one corrective action to be taken to address the performance of the one or more of the network devices.

13. The network device of claim 8, wherein the analysis is a pre-change analysis of how a change in at least one of the one or more variables affects a future performance of the one or more of the network devices.

14. The network device of claim 13, wherein the one or more variables include one or more device configurations and modifications in a number of the network devices operating in the network.

15. One or more non-transitory computer readable media comprising computer-readable instructions, which when executed by one or more processors of a network appliance, cause the network appliance to:
receive a set of information associated with performance of network devices operating in a network;
process using a trained machine learning model the set of information to identify one or more variables indicative of performance of the network devices, the machine learning model being trained to receive as input a set of device utilization information, identify the one or more variables, and provide as output an analysis of the performance of one or more of the network devices; and
generate a user interface to display on a user device a visual representation of the output of the trained machine learning model.

16. The one or more non-transitory computer readable media of claim 15, wherein the set of information include CPU load features, packet loss features, traffic volume features, configuration features of the network devices, and one or more of current device utilization, traffic levels, and feature usage of the network devices.

17. The one or more non-transitory computer readable media of claim 16, wherein the analysis is a root cause analysis of how the one or more variables are affecting the performance of the one or more of the network devices.

18. The one or more non-transitory computer readable media of claim 16, wherein the execution of the computer readable instructions further cause the network appliance to identify the one or more variables affecting the performance of the network devices.

19. The one or more non-transitory computer readable media of claim 15, wherein the analysis includes at least one corrective action to be taken to address the performance of the one or more of the network devices.

20. The one or more non-transitory computer readable media of claim 15, wherein the analysis is a pre-change analysis of how a change in at least one of the one or more variables affects a future performance of the one or more of the network devices.
